(19) United States
(12) Patent Application Publication
(10) Pub. No.: US 2022/0340794 A1
(43) Pub. Date: Oct. 27, 2022

(54) MODIFIED EPOXY ACRYLATE RESIN CONDUCTIVE ADHESIVE AND PREPARATION METHOD AND APPLICATION THEREOF

(71) Applicant: SOLTRIUM ADVANCED MATERIALS TECHNOLOGY, LTD SHENZHEN, Shenzhen, Guangdong (CN)

(72) Inventors: Wen Shi, Shenzhen (CN); Fengzhen Sun, Shenzhen (CN); Delin LI, San Jose, CA (US)

(21) Appl. No.: 17/413,565

(22) PCT Filed: Jan. 17, 2020
(86) PCT No.: PCT/CN2020/072634

§ 371 Date: Jun. 13, 2021

(51) Int. Cl. C09J 163/10; C08K 3/08; C08K 9/02; C08K 7/18

(52) U.S. Cl. CPC C09J 163/10; C08K 3/08; C08K 9/02; C08K 7/18; C08K 2003/085; C08K 2201/001; C08K 2201/006

(57) ABSTRACT

A modified epoxy acrylic resin conductive adhesive is disclosed, based on 100 parts by total mass, including the following components: 49-75 parts of conductive particles, 24-45 parts of modified epoxy propylene resin, 0.5-2.5 parts of silane coupling agent, and 0.5-3.0 parts of initiator. The conductive particles include at least 5% conductive particles with a three-dimensional dendritic microstructure among all the conductive particles. A preparation method and application of the modified epoxy acrylic resin conductive adhesive are disclosed. The modified epoxy acrylic resin conductive adhesive of the present disclosure has advantages in good electrical conductivity, short curing time, strong adhesion, and capability being used for a long-time room temperature operation.

### CROSS-REFERENCES TO RELATED APPLICATIONS

This application is a national-phase application of and claims priority to PCT Patent Application No. PCT/CN2020/072634, filed on Jan. 17, 2020, commonly assigned to Soltrium Advanced Materials Technology, Ltd. Shenzhen with U.S. Attorney Docket No. ST0702-001200US, filed concurrently on Jun. 13, 2021, and U.S. Attorney Docket No. ST0702-001100US, filed concurrently on Jun. 13, 2021, which are incorporated by reference herein for all purposes.

### BACKGROUND OF THE INVENTION

The present disclosure relates to the technical field of semiconductor materials, and specifically relates to a modified epoxy acrylate resin conductive adhesive and preparation method and application thereof.

Conductive adhesives are widely used in the manufacture and assembly of electronic equipment, integrated circuits, semiconductor devices, passive components, solar cells, solar modules and/or light-emitting diodes. Because conductive adhesives provide mechanical bonding and electrical conductivity between two surface components, the conductive adhesive must have good mechanical properties and low-resistance electrical conductivity. Usually, the conductive adhesive is composed of conductive particles, polymer resins and additives. Resin usually provides a mechanical bond between two components, while conductive particles usually provide the required electrical conduction path.

In addition, the morphology of conductive particles in traditional conductive adhesive is mostly spherical, spheroidal, and flaky silver particles, which leads to the contact between two conductive particles to be a point contact. As shown in FIG. 1, the contact between two spherical conductive particles is a point contact. Therefore, in order to improve the conductive performance of the conductive adhesive, usually a method of increasing the number or amount of conductive particles is used. However, this method inevitably increases the production cost of the conductive adhesive while trying to increase the conductivity.

The traditional acrylic resin conductive adhesives have disadvantage of low adhesion. The traditional epoxy acid resin conductive adhesives have advantage of high adhesion but have disadvantage of being too brittle. In addition, the existing conductive adhesives have a long curing time during its application with poor adhesion.

### BRIEF SUMMARY OF THE INVENTION

The present disclosure relates to the technical field of semiconductor materials, and specifically relates to a modified epoxy acrylate resin conductive adhesive and preparation method and application thereof.

In an aspect, the present application provides a modified epoxy acrylate resin conductive adhesive, which solves the problems of poor electrical conductivity, long curing time, poor adhesion, and too brittleness of existing conductive adhesives. Compared with the traditional acrylic resin conductive adhesive, the modified epoxy acrylate resin conductive adhesive provided according to some embodiments of the present disclosure has advantages of good conductivity and strong adhesion. Compared also with the traditional epoxy acid resin conductive adhesive, the modified epoxy acrylate resin conductive adhesive has advantages of higher conductivity and improved toughness.

In another aspect, the present disclosure provides an application of the above modified epoxy acrylate resin conductive adhesive in semiconductor components.

In order to achieve the above objectives, an embodiment of the present disclosure includes a modified epoxy acrylate resin conductive adhesive, based on 100 parts by total mass, including following raw material components: 49˜75 parts of conductive particles, 24˜45 parts of modified epoxy acrylate resin, 0.5˜2.5 parts of silane coupling agent, 0.5˜3.0 parts of initiator.

In some embodiments, the conductive particles include conductive particles with a three-dimensional dendritic microstructure. It means that the conductive adhesive of the present disclosure must contain three-dimensional dendritic conductive particles. Optionally, the conductive particles in the conductive adhesive of the present disclosure include at least 5% conductive particles with the three-dimensional dendritic microstructure among all the conductive particles. Optionally, the conductive particles in the conductive adhesive of the present disclosure includes a mixture of the conductive particles with the three-dimensional dendritic microstructure and conductive particles in spherical or flaky shapes.

The modified acrylate resin conductive adhesive according to some embodiments of the present disclosure can be a light-curing conductive adhesive or a heat-curing conductive adhesive. When the conductive adhesive is selected in application, it can be cured by heat within 1 to 500 seconds at a temperature of 80° C.˜170° C. It also can be cured by light within 1˜30 s under the irradiation of a high-pressure mercury lamp with a power of 500˜1000 W and a lamp distance of 5˜25 cm. In addition, the modified acrylate resin conductive adhesive according to some embodiments of the present disclosure can also be stored for a long time under room temperature conditions of 22° C. to 25° C., indicating that the conductive adhesive can be operated for a long time under room temperature conditions. Furthermore, it shows that the conductivity of the modified acrylate resin conductive adhesive is sufficient for long-term use under various operating conditions for electronic assembly and solar photovoltaic module production. The modified acrylate resin conductive adhesive can also form a conductive path between two substrates or components and the substrate, and can be used in the manufacture and assembly of electronic equipment, integrated circuits, semiconductor devices, passive components, and solar photovoltaic modules.

Optionally, the specific surface area of the conductive particles with a three-dimensional dendritic microstructure is limited within 0.2˜3.5 m²/g.

Optionally, the conductive particles with a three-dimensional dendritic microstructure are silver particles with a three-dimensional dendritic microstructure and/or silver-coated copper particles with a three-dimensional dendritic microstructure. Optionally, the conductive particles are a mixture of spherical silver particles and silver particles with a three-dimensional dendritic microstructure, wherein a mass ratio of the silver particles with the three-dimensional dendritic microstructure and total of the conductive particles is one selected from (0.05˜0.95):1. In other words, the conductive adhesive of the present disclosure must contain silver particles with a three-dimensional dendritic microstructure; and the ratio of the weight of the silver particles with the three-dimensional dendritic microstructure to the total weight of the conductive particles can be 0.05:1; or 0.95:1; or 0.7:1, etc. In addition, the specific surface area of the silver particles with the three-dimensional dendritic microstructure is limited within 0.2˜3.5 m²/g, and the size of the spherical silver particles is in a range of 0.1˜50.0 μm.

Optionally, the conductive particles are a mixture of spherical silver particles and silver-coated copper particles with a three-dimensional dendritic microstructure, wherein a mass ratio of the silver-coated copper particles with the three-dimensional dendritic microstructure to total of the conductive particles is one selected from (0.05˜0.95):1. It is stated that the conductive adhesive of the present disclosure must contain silver-coated copper particles with the three-dimensional dendritic microstructure; and a ratio of the weight of the silver-coated copper particles with the three-dimensional dendritic microstructure to the total weight of the conductive particles can be 0.05:1; or it can also be 0.95:1; or it can also be 0.7:1, etc. In addition, the specific surface area of the silver-coated copper particles with the three-dimensional dendritic microstructure is limited within 0.2˜3.5 m²/g. The particle size of the spherical silver particles is in a range of 0.1˜50.0 μm.

Optionally, the conductive particles also include flaky silver particles. The conductive particles are a mixture of flaky silver particles and silver particles with a three-dimensional dendritic microstructure. A mass ratio of the silver particles with the three-dimensional dendritic microstructure to total of the conductive particles is one selected from (0.05˜0.95):1; it indicates that the conductive adhesive of the present disclosure must contain silver particles with the three-dimensional dendritic microstructure; and that the ratio of the weight of silver particles with three-dimensional dendritic microstructure and the total amount of conductive particles can be 0.05:1; or it can also be 0.95:1; or it can also be 0.7:1, etc. In addition, the specific surface area of the silver particles with the three-dimensional dendritic microstructure is limited within 0.2˜3.5 m²/g. The size of the flaky silver particles is in a range of 0.1˜50.0 μm.

Optionally, the conductive particles are a mixture of flaky silver particles and silver-coated copper particles with a three-dimensional dendritic microstructure. A mass ratio of the silver-coated copper particles with the three-dimensional dendritic microstructure to total of the conductive particles is one selected from (0.05˜0.95):1; it indicates that the modified acrylate resin conductive adhesive of the present disclosure must contain silver-coated copper particles with the three-dimensional dendritic microstructure; and that the ratio of the weight of silver-coated copper particles with three-dimensional dendritic microstructure and the total amount of conductive particles can be 0.05:1; or it can also be 0.95:1; or it can also be 0.7:1, etc. In addition, the specific surface area of the silver-coated copper particles with the three-dimensional dendritic microstructure is limited within 0.2˜3.5 m²/g. The size of the flaky silver particles is in a range of 0.1˜50.0 μm.

Optionally, the conductive particles are a mixture of flaky silver-coated copper particles and silver-coated copper particles with a three-dimensional dendritic microstructure. A mass ratio of the silver-coated copper particles with the three-dimensional dendritic microstructure to total of the conductive particles is one selected from (0.05˜0.95):1; it indicates that the conductive adhesive of the present disclosure must contain silver-coated copper particles with the three-dimensional dendritic microstructure; and that the ratio of the weight of silver-coated copper particles with three-dimensional dendritic microstructure and the total amount of conductive particles can be 0.05:1; or it can also be 0.95:1; or it can also be 0.7:1, etc. In addition, the specific surface area of the silver-coated copper particles with the three-dimensional dendritic microstructure is limited within 0.2˜3.5 m²/g. The size of the flaky silver-coated copper particles is in a range of 0.1˜50.0 μm.

Optionally, the conductive particles are a mixture of spherical silver-coated copper particles and silver-coated copper particles with a three-dimensional dendritic microstructure. A mass ratio of the silver-coated copper particles with the three-dimensional dendritic microstructure to total of the conductive particles is one selected from (0.05˜0.95):1; it indicates that the conductive adhesive of the present disclosure must contain silver-coated copper particles with the three-dimensional dendritic microstructure; and that the ratio of the weight of silver-coated copper particles with three-dimensional dendritic microstructure and the total amount of conductive particles can be 0.05:1; or it can also be 0.95:1; or it can also be 0.7:1, etc. In addition, the specific surface area of the silver-coated copper particles with the three-dimensional dendritic microstructure is limited within 0.2˜3.5 m²/g. The size of the spherical silver-coated copper particles is in a range of 0.1˜50.0 μm.

Optionally, the conductive particles are a mixture of silver particles with a three-dimensional dendritic microstructure and silver-coated copper particles with a three-dimensional dendritic microstructure. A mass ratio of the silver-coated copper particles with the three-dimensional dendritic microstructure to total of the conductive particles is one selected from (0.05˜0.95):1; it indicates that the conductive adhesive of the present disclosure must contain silver-coated copper particles with the three-dimensional dendritic microstructure and silver particles with a three-dimensional dendritic microstructure; and that the ratio of the weight of silver-coated copper particles with three-dimensional dendritic microstructure and the total amount of conductive particles can be 0.05:1; or it can also be 0.95:1; or it can also be 0.7:1, etc.

In addition, the specific surface area of the silver-coated copper particles with the three-dimensional dendritic microstructure is limited within 0.2˜3.5 m²/g. The specific surface area of the silver particles with the three-dimensional dendritic microstructure is limited within 0.2˜3.5 m²/g.

Optionally, the specific surface area of all the conductive particles with a three-dimensional dendritic microstructure in the modified acrylate resin conductive adhesive according to some embodiments of the present disclosure is limited in a range of 0.2˜3.5 m²/g.

Optionally, the size of the spherical particles in the modified acrylate resin conductive adhesive of the disclosure is in a range of 0.1˜50 μm; the size of the flaky particles in the modified acrylate resin conductive adhesive of the disclosure is also in the range of 0.1-50 μm.

By selecting the specific surface area and the particle size in above two numerical ranges, respectively, the modified acrylate resin conductive adhesive of the disclosure can be applied to different scenarios. Generally, the median particle diameter D50 of the conductive particles with a three-dimensional dendritic microstructure is in a range of 0.1 μm to 50.0 μm. In a specific embodiment, the specific surface area of the conductive particles with a three-dimensional dendritic microstructure can be 0.2 m²/g or 3.5 m²/g, or it can also be 2.0 m²/g etc. This is because the specific surface area may affect the electrical conductivity of the modified acrylate resin conductive adhesive, so the specific surface area of the conductive particles with the three-dimensional dendritic microstructure of the present disclosure needs to be limited in the range of 0.2 to 3.5 m²/g to yield acceptable electrical conductivity.

Optionally, the modified epoxy acrylate resin is at least one of polyurethane modified epoxy acrylate, silicone modified epoxy acrylate, acid and anhydride modified epoxy acrylate, phosphoric acid (ester) modified epoxy acrylate, and polyol modified epoxy acrylate. That is to say, in the specific embodiment, the modified epoxy acrylate resin can be any one of the above-mentioned acrylate monomers, or it can be any two or a combination of two or more of the above-mentioned acrylate monomers.

Optionally, the silane coupling agent is at least one of 3-methacryloxypropyldimethoxysilane, 3-methacryloxypropyltrimethoxysilane, 3-methacryloxypropyldiethyl Oxysilane, 3-methacryloxypropyl triethoxy silane, vinyl trimethoxy silane, vinyl triethoxy silane, styrene trimethoxy silane, 3-acrylic propyl trimethoxy silane. That is, in the specific embodiment, the silane coupling agent can be selected from one or more of the above listed silane coupling agents according to actual needs, the purpose of which is to enhance the effect of adhesion.

Optionally, the silane coupling agent used in the present disclosure can set up a “molecular bridge” between the conductive adhesive and the interface between the semiconductor element that needs to be bonded, such as a chip, to connect two materials with very different properties together, and increase the bonding strength.

Optionally, the initiator is at least one of tert-butyl peroxide neodecanoate, tert-butyl peroxide 2-ethylhexyl acid, 1,1′-bis(tert-butylperoxy)-3,3,5-trimethylcyclohexane alkane, 1,1′-bis(tert-amylperoxy)cyclohexane; that is, in specific embodiments, the initiator can be selected from the above listed initiators according to actual needs. The purpose of the initiator is to initiate a curing reaction to form the conductive adhesive.

Furthermore, if the modified acrylate resin conductive adhesive contains only conductive particles with three-dimensional dendritic microstructure, the viscosity of the conductive adhesive may increase, and even affect the printing type of the modified acrylate resin conductive adhesive. Therefore, in the present disclosure, in order to reduce the viscosity of the modified acrylate resin conductive adhesive on the basis of ensuring that the electrical conductivity of the modified acrylate resin conductive adhesive does not change significantly, so that the conductive adhesive has better printability, the conductive particles of the present disclosure also include one or more kinds of, but are not limited to, spherical conductive particles, flaky conductive particles, or spheroidal conductive particles.

In some specific embodiments, the conductive particles in the modified acrylate resin conductive adhesive of the present disclosure may include three-dimensional dendritic silver particles, and one or more kinds of spherical silver particles, flaky silver particles, or spheroidal silver particles.

In some specific embodiments, the conductive particles in the modified acrylate resin conductive adhesive of the present disclosure may include three-dimensional dendritic silver particles, and one or more kinds of spherical silver-coated copper particles, flaky silver-coated copper particles, or spheroidal silver-coated copper particles.

In some specific embodiments, the conductive particles in the modified acrylate resin conductive adhesive of the present disclosure may include three-dimensional dendritic silver-coated copper particles, and one or more kinds of spherical silver-coated copper particles, flaky silver-coated copper particles, or spheroidal silver-coated copper particles.

In some specific embodiments, the conductive particles in the modified acrylate resin conductive adhesive of the present disclosure may include three-dimensional dendritic silver-coated copper particles, and one or more kinds of spherical silver particles, flaky silver particles, or spheroidal silver particles.

In some specific embodiments, the conductive particles in the modified acrylate resin conductive adhesive of the present disclosure may include three-dimensional dendritic silver-coated copper particles, three-dimensional dendritic silver particles, as well as one or more kinds of spherical silver-coated copper particles, flaky silver-coated copper particles, spherical silver-coated copper particles, and spherical silver. particles, flake silver particles or spheroidal silver particles.

In yet another aspect, the present disclosure also provides another technical solution as a method for preparing the modified epoxy acrylate resin conductive adhesive, the method includes the following steps:

Step 1, according to total mass parts as 100 parts, weighing the following raw material components: 49˜75 parts of conductive particles, 24˜45 parts of modified epoxy acrylate resin, 0.5˜2.5 parts of silane coupling agent, 0.5˜3.0 parts of initiator. It is noted that weighing the raw material components may have about 10% error margin. The conductive particles include at least 5% conductive particles with a three-dimensional dendritic microstructure with rest conductive particles being spherical or flaky shaped particles. Optionally, the conductive particles, either in the three-dimensional dendritic or spherical or flaky shape, contains silver or copper coated by silver.

Step 2, mixing the modified glycidyl ester resin, silane coupling agent and initiator described in step 1 into the reaction, stirring evenly, then adding the conductive particles, stirring evenly to obtain a mixture;

Step 3, grinding the mixture to obtain the modified epoxy acrylate resin conductive adhesive.

In an alternative embodiment, the present disclosure provides a third technical solution as a method for using the above-mentioned modified epoxy acrylate resin conductive adhesive in semiconductor components.

In the specific embodiment, the method of using includes first printing the modified epoxy acrylate resin conductive adhesive of the present disclosure on a substrate of a semiconductor element, and then placing the substrate printed with the acrylic conductive adhesive in an environment at 80° C. to 170° C. (for example, 150° C.), curing for 5˜300 s (for example, 15 s) to obtain the semiconductor element containing the modified epoxy acrylate resin conductive adhesive of the present disclosure to be ready for packaging a semiconductor device.

Compared with the prior art, 1) the modified epoxy acrylate resin conductive adhesive according to some embodiments of the present disclosure uses conductive particles with a three-dimensional dendritic microstructure which causes the contact between the two conductive particles to be a multi-point contact. The contact resistance with the multi-point contact is greatly reduced comparing to prior art. As the conductive performance is greatly improved, the amount of conductive particles used can be reduced, thereby reducing costs and improving performance; 2) The modified epoxy acrylate resin conductive adhesive according to some embodiments of the present disclosure uses modified epoxy acrylic and silane coupling agents as adhesion promoters so that the conductive adhesive has advantageous characteristics of fast curing speed, strong adhesion, and long-time operability at room temperature. In addition, the preparation method of the present disclosure is simple and easy to operate, so it is convenient for industrial production.

### BRIEF DESCRIPTION OF THE DRAWINGS

FIG. 1 is a schematic diagram of the contact between two spherical conductive particles in an existing conductive paste; wherein 001 represents the spherical conductive particle, and 0011a represents the contact point between the two spherical conductive particles.

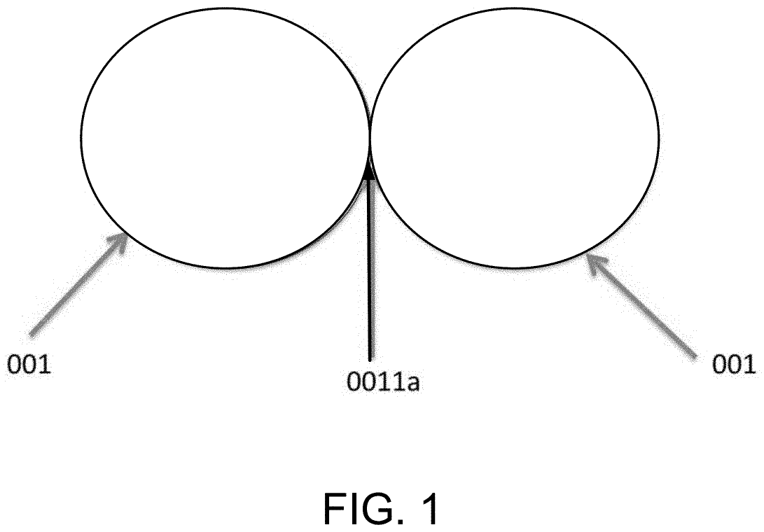

FIG. 2 is a scanning electron microscope (SEM) image of three-dimensional dendritic silver particles in a modified epoxy acrylate resin conductive paste provided in the present disclosure.

FIG. 3 is another SEM image of three-dimensional dendritic silver particles in a modified epoxy acrylate resin conductive paste provided in the present disclosure.

FIG. 4 is a schematic diagram of the contact between three-dimensional dendritic conductive particles and spherical conductive particles in a modified epoxy acrylate resin conductive paste provided in the present disclosure; among them, 002 represents three-dimensional dendritic conductive particles, 001 represents spherical conductive particles; 0012a is the contact point.

FIG. 5 is a schematic diagram of the contact between the three-dimensional dendritic conductive particles and the three-dimensional dendritic conductive particles in a modified epoxy acrylate resin conductive paste provided in the present disclosure; among them, 002a and 002b represent the three-dimensional dendritic conductive particles, and 002ab represents the contact point.

FIG. 6 is a schematic diagram of bond strength test for the modified epoxy acrylate resin conductive paste provided in the present disclosure.

FIG. 7 is a schematic diagram of die shearing test for the modified epoxy acrylate conductive adhesive provided in the present disclosure.

### DETAILED DESCRIPTION OF THE INVENTION

To make the technical problem to be solved, the technical solution, and the beneficial effects of the present disclosure clearer, the present disclosure is further described in detail with reference to examples and accompanying drawings. It should be understood that the specific examples described herein are merely provided for illustrating, instead of limiting the present disclosure.

In the present disclosure, the conductive particles used in the following embodiments of the modified epoxy acrylate resin conductive paste contains particles with a three-dimensional dendritic microstructure, for example, three-dimensional dendritic silver particles and three-dimensional dendritic silver-coated copper particles. Optionally, the conductive particles with the three-dimensional dendritic microstructure can be prepared by existing technology or purchased.

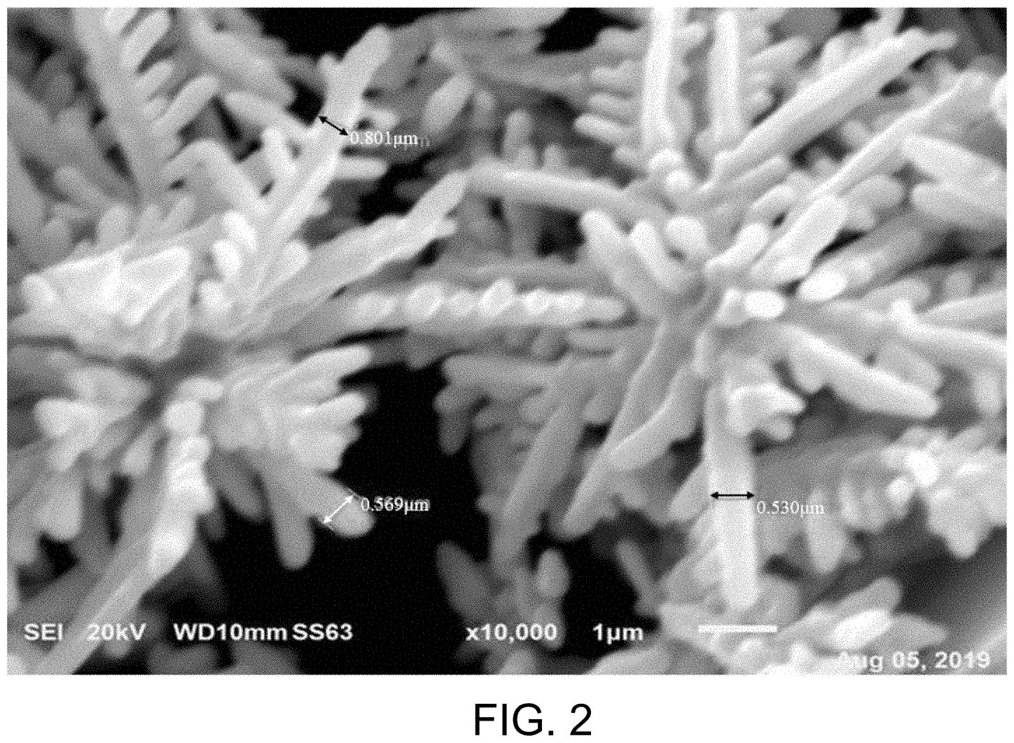

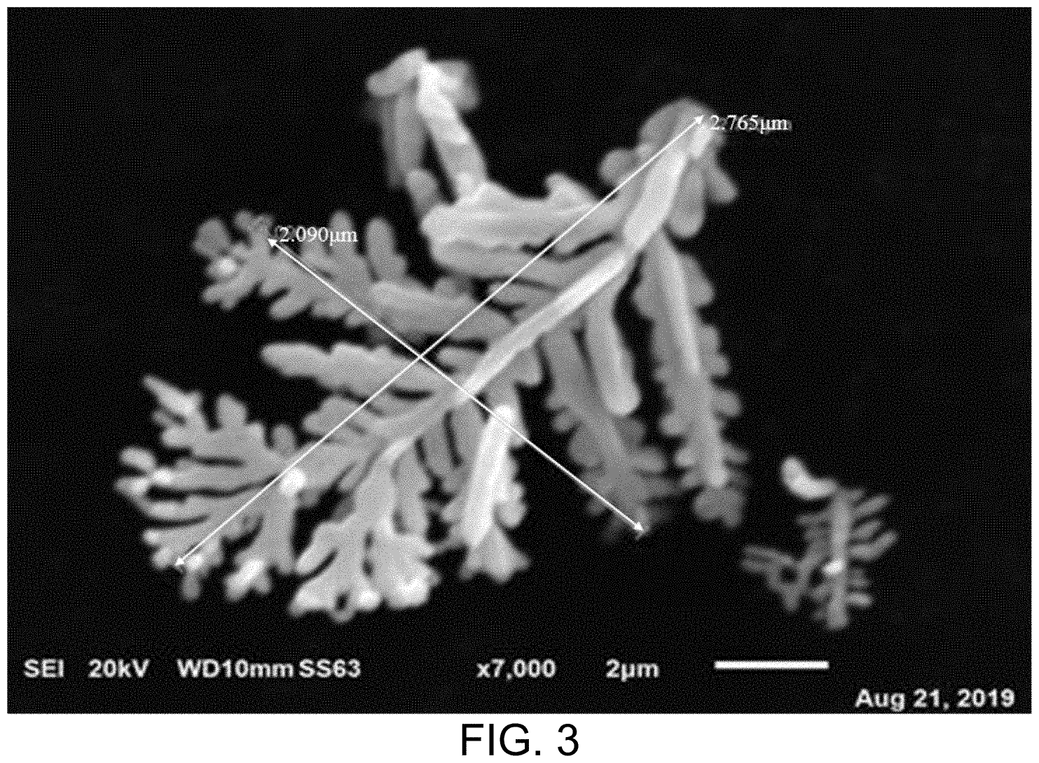

Sample images of the three-dimensional dendritic silver particles obtained from the purchase were taken by scanning electron microscope (SEM) as shown in FIG. 2 and FIG. 3.

In the following specific embodiments, the conductive particles include one or more kinds of the three-dimensional dendritic silver particles, three-dimensional dendritic silver-coated copper particles, spherical silver particles, flaky silver particles, spheroidal silver particles, spherical silver-coated copper particles, flaky silver-coated copper particles, and spheroidal silver-coated copper particles are all obtained through purchase.

### Example 1

A modified epoxy acrylate resin conductive adhesive provided in this example, as listed in Table 1, based on a total weight of 100 parts, includes the following raw material components: 20 parts of spherical silver particles; 50 parts of three-dimensional dendritic silver particles; 28 parts of polyurethane modified epoxy acrylate; 1.0 part of 3-methacryloxypropyltrimethoxysilane; 1.0 part of tert-butyl peroxyneodecanoate.

By calculation, among the above components, a ratio of the weight of the three-dimensional dendritic silver particles to the total weight of the conductive particles is 5:7.

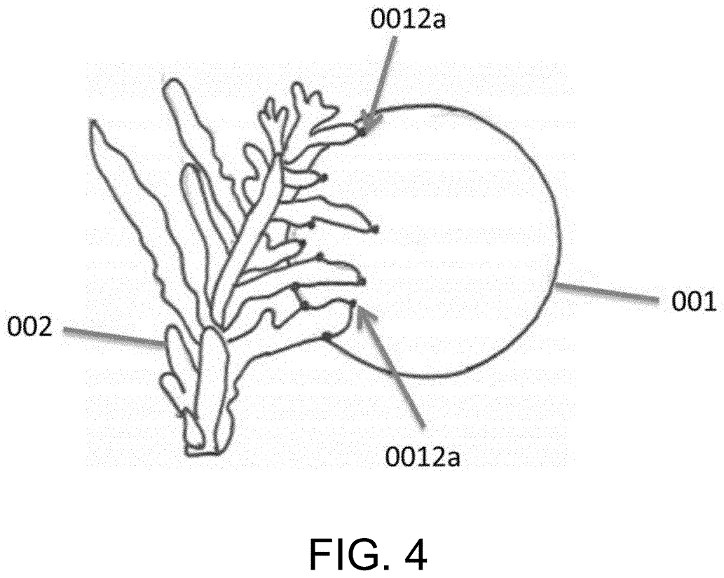

Referring to FIG. 4, the contact between the three-dimensional dendritic silver particles and spherical silver particles belong to a kind of multi-point contact. Among them, the spherical silver particles in this example have a median particle diameter D50 of 1.5 μm and a specific surface area of 0.36 m²/g; the three-dimensional dendritic silver particles have a D50 of 4.0 μm and a specific surface area of 0.69 m²/g.

The modified epoxy acrylate resin conductive adhesive provided in this example is prepared by a method shown below, which includes the following steps:

Step 1, according to the total weight of 100 parts, weighing 20 parts of spherical silver particles; 50 parts of three-dimensional dendritic silver particles; 28 parts of polyurethane-modified epoxy acrylate; 1.0 part of 3-methacryloxypropyltrimethoxysilane; and 1.0 part of tert-butyl peroxyneodecanoate;

Step 2, putting the polyurethane-modified epoxy acrylate, 3-methacryloxypropyltrimethoxysilane and tert-butyl peroxide neodecanoate from step 1 in a stainless steel container and stirring evenly, then adding spherical silver particles and three-dimensional dendritic silver particles, and mixing them evenly to obtain a mixture;

Step 3, placing the mixture on a three-roll mill for further grinding to obtain 200 g of modified epoxy acrylate resin conductive adhesive.

In order to verify the performance of the modified epoxy acrylate resin conductive adhesive provided in the example, the following tests are performed for evaluating viscosity performance, thermal expansion coefficient, and glass transition temperature, curing temperature and time, volume resistivity, and shear strength.

Among them, the viscosity of the conductive paste is tested by using a viscometer at 25° C.; the thermal expansion coefficient is tested by Thermomechanical Analysis (TMA) method; the glass transition temperature is tested by Differential Scanning calorimetry (DSC) method; the curing temperature and time are tested in a chain heating furnace.

The test method for the volume resistivity of the conductive paste is: printing the conductive adhesive sample on a glass sheet, and then curing it at 150° C. and a curing time of 15 s; the cured conductive paste has a width of 5 mm, a height of 42 μm, and a length of 70 mm; then testing its resistance and calculating the volume resistivity of its conductive gel according to the following formula:

$$ρ = R \times \frac{b \times d}{L}$$

In the formula: L, b, d are the length, width and thickness (cm) of the conductive paste sample, R is the resistance of the conductive paste sample (Ω), and p is the volume resistivity of the conductive paste sample (Ω·cm).

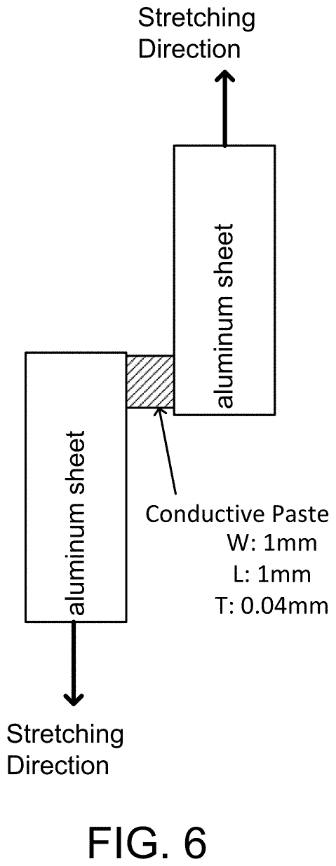

The shear strength test process of conductive paste is as follows: refer to the national standard GB/T 7124-2008 Determination of Tensile Shear Strength of Adhesive (Rigid Material vs. Rigid Material) method to measure the adhesive strength of the conductive paste sample. FIG. 6 is a schematic diagram of the shear strength test with two aluminum sheets attached with a conductive paste sample film. During the measurement, the tensile machine stretched two aluminum sheets at a speed of 200 mm/min in a direction of 180 degrees until the conductive paste film was broken. Write down the breaking load on the dial of the testing machine, take 6 tensile samples for testing, and press Formula to calculate the shear strength (W):

W=P/S

In the formula: W is the shear strength, P is the breaking load, S is the overlap area. In addition, there are 5 tensile samples in this test, and average value of the test results is recorded (see Table 2).

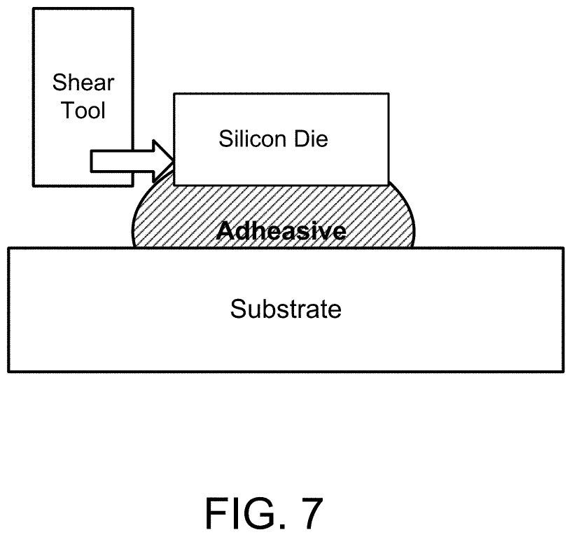

FIG. 7 shows a schematic diagram of a die Shearing Test per Mil-Std-883 Method 2019. A dummy silicon die with x-y dimensions of 5×3 mm and height of 1 mm is used. A copper substrate with surface coating of NiPdAu is used. The modified epoxy acrylate conductive adhesive prepared from this example is printed on the substrate, then the dummy silicon die is attached on the modified epoxy acrylate conductive adhesive followed by a curing reaction at 150° C. for 30 min. The die shearing stress test is then performed and a die shearing strength result of the silicon die is recorded (see Table 2).

### Example 2

The modified epoxy acrylate resin conductive adhesive provided in this example, as listed in Table 1, based on a total weight of 100 parts, includes the following raw material components: 20 parts of flaky silver particles; 50 parts of three-dimensional dendritic silver particles; 28 parts of polyurethane modified epoxy acrylate; 1.0 part of 3-methacryloxypropyltrimethoxysilane; and 1.0 part of tert-butyl peroxyneodecanoate.

By calculation, among the above components, a ratio of the weight of the three-dimensional dendritic silver particles to the total weight of the conductive particles is 5:7.

In the example, the D50 of the flaky silver particles is 1.5 μm, and the specific surface area of the flaky silver particles is 0.41 m²/g; the D50 of the three-dimensional dendritic silver particles is 4.0 μm, and the specific surface area of the three-dimensional dendritic silver particles is 0.69 m²/g.

The preparation method of the modified epoxy acrylate resin conductive adhesive of this example is the same as the preparation method of Example 1.

The conductive paste according to the example is also tested for curing time, volume resistivity, glass-transition temperature, bonding strength, cracking. All test methods are the same as those of Example 1. The test results are also summarized in Table 2.

### Example 3

The modified epoxy acrylate resin conductive adhesive provided in this example, as listed in Table 1, based on a total weight of 100 parts, includes the following raw material components: 20 parts of spherical silver particles; 50 parts of three-dimensional dendritic silver-coated copper particles; 28 parts of polyurethane modified ring oxyacrylate; 1.0 part of 3-methacryloxypropyltrimethoxysilane; and 1.0 part of tert-butyl peroxyneodecanoate.

By calculation, among the above components, a ratio of the weight of the three-dimensional dendritic silver-coated copper particles to the total weight of the conductive particles is 5:7.

In the example, the D50 of the spherical silver particles is 1.5 μm, and the specific surface area of the spherical silver particles is 0.32 m²/g; the D50 of the three-dimensional dendritic silver-coated copper particles is 4.0 μm, and the specific surface area of the three-dimensional dendritic silver-coated copper particles is 0.59 m²/g.

The preparation method of the modified epoxy acrylate resin conductive adhesive of this example is the same as the preparation method of Example 1.

The conductive paste according to the example is also tested for curing time, volume resistivity, glass-transition temperature, bonding strength, cracking. All test methods are the same as those of Example 1. The test results are also summarized in Table 2.

### Example 4

The modified epoxy acrylate resin conductive adhesive provided in this example, as listed in Table 1, based on a total weight of 100 parts, includes the following raw material components: 20 parts of flaky silver particles; 50 parts of three-dimensional dendritic silver-coated copper particles; 28 parts of polyurethane modification epoxy acrylate; 1.0 part of 3-methacryloxypropyl trimethoxysilane; and 1.0 part of tert-butyl peroxyneodecanoate.

By calculation, among the above components, a ratio of the weight of the three-dimensional dendritic silver-coated copper particles to the total weight of the conductive particles is 5:7.

In the example, the D50 of the flaky silver particles in this example is 1.5 μm, and the specific surface area of the flaky silver particles is 0.36 m²/g; the D50 of the three-dimensional dendritic silver-coated copper particles is 4.5 μm, and the specific surface area of the three-dimensional dendritic silver-coated copper particles is 0.59 m²/g.

The preparation method of the modified epoxy acrylate resin conductive adhesive of this example is the same as the preparation method of Example 1.

The conductive paste according to the example is also tested for curing time, volume resistivity, glass-transition temperature, bonding strength, cracking. All test methods are the same as those of Example 1. The test results are also summarized in Table 2.

### Example 5

The modified epoxy acrylate resin conductive adhesive provided in this example, as listed in Table 1, based on a total weight of 100 parts, includes the following raw material components: 70 parts of three-dimensional dendritic silver particles; 28 parts of polyurethane-modified epoxy acrylate; 1.0 part of 3-methacryloxypropyl trimethoxysilane; 1.0 part of tert-butyl peroxyneodecanoate.

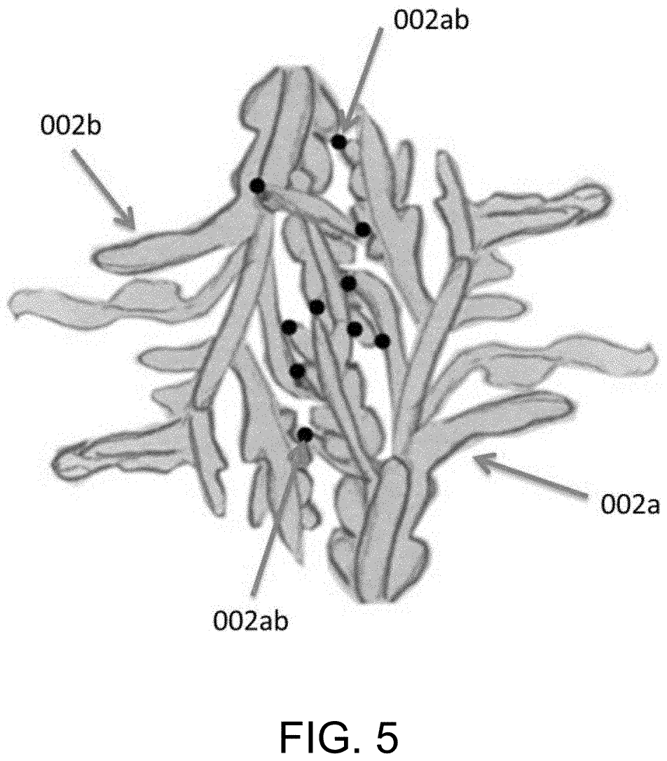

In the example, all conductive particles are particles with three-dimensional dendritic microstructure. Referring to FIG. 5, the contact between two three-dimensional dendritic silver particles belong to a kind of multi-point contact. The median particle diameter D50 of the three-dimensional dendritic silver particles is 4.0 μm, and the specific surface area of the three-dimensional dendritic silver particles is 0.69 m²/g.

The preparation method of the modified epoxy acrylate resin conductive adhesive of this example is the same as the preparation method of Example 1.

The conductive paste according to the example is also tested for curing time, volume resistivity, glass-transition temperature, bonding strength, cracking. All test methods are the same as those of Example 1. The test results are also summarized in Table 2.

### Example 6

The modified epoxy acrylate resin conductive adhesive provided in this example, as listed in Table 1, based on a total weight of 100 parts, includes the following raw material components: 70 parts of three-dimensional dendritic silver-coated copper particles; 28 parts of polyurethane-modified epoxy acrylate; 1.0 part of 3-methacryloxypropyl trimethoxysilane; and 1.0 part of tert-butyl peroxyneodecanoate.

In the example, the D50 of the three-dimensional dendritic silver-coated copper particles is 4.5 μm, and the specific surface area of the three-dimensional dendritic silver-coated copper particles is 0.59 m²/g.

The preparation method of the modified epoxy acrylate resin conductive adhesive of this example is the same as the preparation method of Example 1.

The conductive paste according to the example is also tested for curing time, volume resistivity, glass-transition temperature, bonding strength, cracking. All test methods are the same as those of Example 1. The test results are also summarized in Table 2.

### Example 7

The modified epoxy acrylate resin conductive adhesive provided in this example, as listed in Table 1, based on a total weight of 100 parts, includes the following raw material components: 70 parts of three-dimensional dendritic silver particles; 28 parts of epoxy acrylate; 1.0 part of 3-methacryloxypropyl trimethoxysilane; and 1.0 part of tert-butyl peroxyneodecanoate.

In the example, the D50 of the three-dimensional dendritic silver particles is 4.0 μm, and the specific surface area of the three-dimensional dendritic silver particles is 0.69 m²/g.

The preparation method of the modified epoxy acrylate resin conductive adhesive of this example is the same as the preparation method of Example 1.

The conductive paste according to the example is also tested for curing time, volume resistivity, glass-transition temperature, bonding strength, cracking. All test methods are the same as those of Example 1. The test results are also summarized in Table 2.

### Example 8

The modified epoxy acrylate resin conductive adhesive provided in this example, as listed in Table 1, based on a total weight of 100 parts, includes the following raw material components: 70 parts of three-dimensional dendritic silver particles; 28 parts of silicone modified epoxy acrylate; 1.0 part of 3-methacryloxypropyl trimethoxysilane; and 1.0 part of tert-butyl peroxyneodecanoate.

In the example, the D50 of the three-dimensional dendritic silver particles is 4.0 μm, and the specific surface area of the three-dimensional dendritic silver particles is 0.69 m²/g.

The preparation method of the modified epoxy acrylate resin conductive adhesive of this example is the same as the preparation method of Example 1.

The conductive paste according to the example is also tested for curing time, volume resistivity, glass-transition temperature, bonding strength, cracking. All test methods are the same as those of Example 1. The test results are also summarized in Table 2.

### Example 9

The modified epoxy acrylate resin conductive adhesive provided in this example, as listed in Table 1, based on a total weight of 100 parts, includes the following raw material components: 70 parts of three-dimensional dendritic silver particles; 28 parts of polyurethane-modified epoxy acrylate; 1.0 part of 3-methacryloxypropyl trimethoxysilane; and 1.0 part of tert-butyl peroxyneodecanoate.

In the example, the D50 of the three-dimensional dendritic silver particles is 2.0 μm, and the specific surface area of the three-dimensional dendritic silver particles is 3.5 m²/g.

The preparation method of the modified epoxy acrylate resin conductive adhesive of this example is the same as the preparation method of Example 1.

The conductive paste according to the example is also tested for curing time, volume resistivity, glass-transition temperature, bonding strength, cracking. All test methods are the same as those of Example 1. The test results are also summarized in Table 2.

### Example 10

The modified epoxy acrylate resin conductive adhesive provided in this example, as listed in Table 1, based on a total weight of 100 parts, includes the following raw material components: 70 parts of three-dimensional dendritic silver particles; 28 parts of polyurethane-modified epoxy acrylate; 1.0 part of 3-methacryloxypropyl trimethoxysilane; and 1.0 part of tert-butyl peroxyneodecanoate.

In the example, the D50 of the three-dimensional dendritic silver particles is 1.7 μm, and the specific surface area of the three-dimensional dendritic silver particles is 4.19 m²/g. The preparation method of the modified epoxy acrylate resin conductive adhesive in this example is the same as that in Example 1.

The conductive paste according to the example is also tested for curing time, volume resistivity, glass-transition temperature, bonding strength, cracking. All test methods are the same as those of Example 1. The test results are also summarized in Table 2.

### Example 11

The modified epoxy acrylate resin conductive adhesive provided in this example, as listed in Table 1, based on a total weight of 100 parts, includes the following raw material components: 55 parts of three-dimensional dendritic silver particles; 43 parts of polyurethane-modified epoxy acrylate; 1.0 part of 3-methacryloxypropyl trimethoxysilane; and 1.0 part of tert-butyl peroxyneodecanoate.

In the example, the D50 of the three-dimensional dendritic silver particles is 1.7 μm, and the specific surface area of the three-dimensional dendritic silver particles is 4.19 m²/g. The preparation method of the modified epoxy acrylate conductive adhesive in this example is the same as that in Example 1.

The conductive adhesive according to the example is also tested for curing time, volume resistivity, glass-transition temperature, bonding strength, cracking. All test methods are the same as those of Example 1. The test results are also summarized in Table 2.

### Example 12

A modified epoxy acrylate resin conductive adhesive provided in this example, as listed in Table 1, based on a total weight of 100 parts, includes the following raw material components: 20 parts of spherical silver particles; 40 parts of three-dimensional dendritic silver particles; 38 parts of polyurethane modified epoxy acrylate; 1.0 part of 3-methacryloxypropyltrimethoxysilane; 1.0 part of tert-butyl peroxyneodecanoate.

The spherical silver particles in this example have a median particle diameter D50 of 1.5 μm and a specific surface area of 0.36 m²/g; the three-dimensional dendritic silver particles have a D50 of 4.0 μm and a specific surface area of 0.69 m²/g. The preparation method of the modified epoxy acrylate conductive adhesive in this example is the same as that in Example 1.

The conductive adhesive according to the example is also tested for curing time, volume resistivity, glass-transition temperature, bonding strength, cracking. All test methods are the same as those of Example 1. The test results are also summarized in Table 2.

### Comparative Example 1

This comparative example provides a conductive adhesive, based on a total weight of 100 parts, including the following raw material components: 70 parts of spherical silver particles; 28 parts of polyurethane-modified epoxy acrylate; 1.0 part of 3-methacryloyloxy propyl trimethoxysilane; and 1.0 part of tert-butyl peroxyneodecanoate.

In this example, the D50 of the spherical silver particles is 1.5 μm; the specific surface area of the spherical silver particles is 0.36 m²/g.

The preparation method of the conductive adhesive in this example is the same as that in Example 1.

The conductive adhesive of this comparative example was also tested for curing time, volume resistivity test and bonding strength test. The specific method for each test is the same as that of Example 1. The results obtained are summarized in Table 2.

### Comparative Example 1

This comparative example provides a conductive adhesive, based on a total weight of 100 parts, including the following raw material components: 70 parts of flaky silver particles; 28 parts of polyurethane-modified epoxy acrylate; 1.0 part of 3-methacryloyl oxypropyl trimethoxysilane; and 1.0 part of tert-butyl peroxyneodecanoate.

In the example, the D50 of the flaky silver particles is 1.5 μm; the specific surface area of the flaky silver particles is 0.41 m²/g.

The preparation method of the conductive adhesive in this example is the same as that in Example 1.

TABLE 1
The content and parameters of each component of the modified epoxy acrylate resin
conductive adhesive obtained in Examples 1 to 12 and the conductive adhesive
in Comparative example 1 and Comparative example 2

| | Conductive particles | | Modified | Silane | |
|---|---|---|---|---|---|
| | | 3D | epoxy | coupling | |
| Examples | Spherical/Flaky | dendritic | acrylate | agent | Initiator |
| 1 | Spherical silver | Dendritic | Polyurethane | Methacryloxy | Tert-Butyl |
| | particles | silver | modified | propyl | peroxyneode- |
| | 20 parts; | particles | epoxy | trimethoxyl | canoate |
| | D50 1.5 μm; | 50 parts; | acrylate | silane | 1 part |
| | Specific surface | D50 4.0 μm; | 28 parts | 1 part | |
| | area 0.36 m²/g | Specific | | | |
| | | surface area | | | |
| | | 0.69 m²/g | | | |
| 2 | Flaky silver | Dendritic | Polyurethane | Methacryloxy | Tert-Butyl |
| | particles | silver | modified | propyl | peroxyneode- |
| | 20 parts; | particles | epoxy | trimethoxyl | canoate |
| | D50 1.5 μm; | 50 parts; | acrylate | silane | 1 part |
| | Specific surface | D50 4.0 μm; | 28 parts | 1 part | |
| | area 0.41 m²/g | Specific | | | |
| | | surface area | | | |
| | | 0.69 m²/g | | | |
| 3 | Spherical silver | Dendritic | Polyurethane | Methacryloxy | Tert-Butyl |
| | particles | silver- | modified | propyl | peroxyneode- |
| | 20 parts | coated | epoxy | trimethoxyl | canoate |
| | D50 1.5 μm; | copper | acrylate | silane | 1 part |
| | Specific surface | particles | 28 parts | 1 part | |
| | area 0.32 m²/g | 50 parts; | | | |
| | | D50 4.5 μm; | | | |
| | | Specific | | | |
| | | surface area | | | |
| | | 0.59 m²/g | | | |
| 4 | Flaky silver | Dendritic | Polyurethane | Methacryloxy | Tert-Butyl |
| | particles | silver- | modified | propyl | peroxyneode- |
| | 20 parts | coated | epoxy | trimethoxyl | canoate |
| | D50 1.5 μm; | copper | acrylate | silane | 1 part |
| | Specific surface | particles | 28 parts | 1 part | |
| | area 0.36 m²/g | 50 parts; | | | |
| | | D50 4.5 μm; | | | |
| | | Specific | | | |
| | | surface area | | | |
| | | 0.59 m²/g | | | |
| 5 | None | Dendritic | Polyurethane | Methacryloxy | Tert-Butyl |
| | | silver | modified | propyl | peroxyneode- |
| | | particles | epoxy | trimethoxyl | canoate |
| | | 70 parts; | acrylate | silane | 1 part |
| | | D50 4.0 μm; | 28 parts | 1 part | |
| | | Specific | | | |
| | | surface area | | | |
| | | 0.69 m²/g | | | |
| 6 | None | Dendritic | Polyurethane | Methacryloxy | Tert-Butyl |
| | | silver- | modified | propyl | peroxyneode- |
| | | coated | epoxy | trimethoxyl | canoate |
| | | copper | acrylate | silane | 1 part |
| | | particles | 28 parts | 1 part | |
| | | 70 parts; | | | |
| | | D50 4.5 μm; | | | |
| | | Specific | | | |
| | | surface area | | | |
| | | 0.59 m²/g | | | |
| 7 | None | Dendritic | Epoxy | Methacryloxy | Tert-Butyl |
| | | silver | acrylate | propyl | peroxyneode- |
| | | particles | 28 parts | trimethoxyl | canoate |
| | | 70 parts; | | silane | 1 part |
| | | D50 4.0 μm; | | 1 part | |
| | | Specific | | | |
| | | surface area | | | |
| | | 0.69 m²/g | | | |
| 8 | None | Dendritic | Silicone | Methacryloxy | Tert-Butyl |
| | | silver | modified | propyl | peroxyneode- |
| | | particles | epoxy | trimethoxyl | canoate |
| | | 70 parts; | acrylate | silane | 1 part |
| | | D50 4.0 μm; | 28 parts | 1 part | |
| | | Specific | | | |
| | | surface area | | | |
| | | 0.69 m²/g | | | |
| 9 | None | Dendritic | Polyurethane | Methacryloxy | Tert-Butyl |
| | | silver | modified | propyl | peroxyneode- |
| | | particles | epoxy | trimethoxyl | canoate |
| | | 70 parts; | acrylate | silane | 1 part |
| | | D50 2.0 μm; | 28 parts | 1 part | |
| | | Specific | | | |
| | | surface area | | | |
| | | 3.5 m²/g | | | |
| 10 | None | Dendritic | Polyurethane | Methacryloxy | Tert-Butyl |
| | | silver | modified | propyl | peroxyneode- |
| | | particles | epoxy | trimethoxyl | canoate |
| | | 70 parts; | acrylate | silane | 1 part |
| | | D50 1.7 μm; | 28 parts | 1 part | |
| | | Specific | | | |
| | | surface area | | | |
| | | 4.19 m²/g | | | |
| 11 | None | Dendritic | Polyurethane | Methacryloxy | Tert-Butyl |
| | | silver | modified | propyl | peroxyneode- |
| | | particles | epoxy | trimethoxyl | canoate |
| | | 55 parts; | acrylate | silane | 1 part |
| | | D50 1.7 μm; | 43 parts | 1 part | |
| | | Specific | | | |
| | | surface area | | | |
| | | 4.19 m²/g | | | |
| 12 | Spherical silver | Dendritic | Polyurethane | Methacryloxy | Tert-Butyl |
| | particles | silver | modified | propyl | peroxyneode- |
| | 20 parts; | particles | epoxy | trimethoxyl | canoate |
| | D50 1.5 μm; | 40 parts; | acrylate | silane | 1 part |
| | Specific surface | D50 4.0 μm; | 38 parts | 1 part | |
| | area 0.36 m²/g | Specific | | | |
| | | surface area | | | |
| | | 0.69 m²/g | | | |
| Comparative | Spherical silver | None | Polyurethane | Methacryloxy | Tert-Butyl |
| Example 1 | particles | | modified | propyl | peroxyneode- |
| | 70 parts; | | epoxy | trimethoxyl | canoate |
| | D50 1.5 μm; | | acrylate | silane | 1 part |
| | Specific surface | | 28 parts | 1 part | |
| | area 0.36 m²/g | | | | |
| Comparative | Flaky silver | None | Polyurethane | Methacryloxy | Tert-Butyl |
| Example 2 | particles | | modified | propyl | peroxyneode- |
| | 20 parts; | | epoxy | trimethoxyl | canoate |
| | D50 1.5 μm; | | acrylate | silane | 1 part |
| | Specific surface | | 28 parts | 1 part | |
| | area 0.41 m²/g | | | | |

Compared with Examples 1-5, Comparative Example 1 and Comparative Example 2 differ in that: Comparative Example 1 and Comparative Example 2 do not contain conductive particles with three-dimensional dendritic microstructure, yielding high volume resistivity to the corresponding conductive adhesive. Examples 1-4 contain a mixture of spherical or flaky conductive particles with particles in three-dimensional dendritic structures. Example 5 contains only dendritic particles and does not contain spherical or flaky conductive particles. Volume resistivity of the conductive adhesive based on Examples 1-5 is much lower especially with Example 5, indicating great benefit of including dendritic structure conductive particles.

Compared with Example 5, Example 10 is different in that: the specific surface area of the conductive particles with three-dimensional dendritic microstructure of the conductive adhesive is different. The specific surface area of Example 5 is 0.69 m²/g, which is between 0.2 and 3.5 m²/g. However, the specific surface area of the conductive particles with three-dimensional dendritic microstructure of Example 10 is as high as 4.19 m²/g, making the printing ability of the adhesive significantly worse.

In order to verify the performance of the modified epoxy acrylate resin conductive adhesive according to some embodiments of the present disclosure, the conductive adhesives obtained in Examples 1-12 and Comparative Examples 1-2 were tested for viscosity performance, thermal expansion coefficient, glass transition temperature, curing temperature and time, volume resistivity, shear strength, and die shearing strength.

Among them, the viscosity of the modified epoxy acrylate resin conductive adhesive is tested by using a viscometer at 25° C.; the thermal expansion coefficient is tested by the TMA method; the glass transition temperature is tested by the DSC method; the curing temperature and time are tested in a chain heating furnace.

The test method for the volume resistivity of the modified epoxy acrylate resin conductive paste is: printing the conductive adhesive sample on a glass sheet, and then curing it at a curing temperature of 150° C. and a curing time of 15 s; the cured conductive paste has a width of 5 mm, a height of 42 μm, and a length of 70 mm; then testing its resistance and calculating the volume resistivity of its conductive gel according to the following formula:

$$ρ = R \times \frac{b \times d}{L}$$

In the formula: L, b, d are the length, width and thickness (cm) of the conductive paste sample, R is the resistance of the conductive paste sample (Ω), and ρ is the volume resistivity of the conductive paste sample (Ω·cm).

The shear strength test process of the modified epoxy acrylate resin conductive paste is as follows: refer to the national standard GB/T 7124-2008 Determination of Tensile Shear Strength of Adhesive (Rigid Material vs. Rigid Material) method to measure the adhesive strength of the conductive paste sample. FIG. 6 is a schematic diagram of the shear strength test with two aluminum sheets attached with a conductive paste sample film of 1×1×0.04 mm. During the measurement, the tensile machine stretched two aluminum sheets at a speed of 200 mm/min in a direction of 180 degrees until the conductive paste film was broken. Write down the breaking load on the dial of the testing machine, take 6 tensile samples for testing, and press Formula to calculate the shear strength (W):

### W=P/S

In the formula: W is the shear strength, P is the breaking load, S is the overlap area. In addition, there are 5 tensile samples in this test, and average value of the test results is recorded.

FIG. 7 shows a schematic diagram of a die Shearing Test per Mil-Std-883 Method 2019. A dummy silicon die with x-y dimensions of 5×3 mm and height of 1 mm is used. A copper substrate with surface coating of NiPdAu is used. The modified epoxy acrylate conductive adhesive prepared from this example is printed on the substrate, then the dummy silicon die is attached on the modified epoxy acrylate conductive adhesive followed by a curing reaction at 150° C. for 30 min. The die shearing test is then performed and a die shearing strength result of the silicon die is recorded (see Table 2).

The specific results of the tests performed on the modified epoxy acrylate resin conductive adhesives of the above-mentioned Examples 1 to 12 and Comparative Examples 1 to 2 are shown in Table 2 below.

TABLE 2
The performance data table of the conductive adhesive samples of Example 1 to
Example 12 and Comparative Example 1 to Comparative Example 2 (represented by l′ to 2′)

| | Example | | | | | | | | | | | | | |
|---|---|---|---|---|---|---|---|---|---|---|---|---|---|---|
| Test Item | 1 | 2 | 3 | 4 | 5 | 6 | 7 | 8 | 9 | 10 | 11 | 12 | 1 | 2' |
| Thermal | 115 ± 10 | 115 ± 10 | 115 ± 10 | 115 ± 10 | 115 ± 10 | 115 ± 10 | 115 ± 10 | 115 ± 10 | 115 ± 10 | 115 ± 10 | 115 ± 010 | 115 ± 010 | 115 ± 010 | 115 ± 010 |
| expansion | | | | | | | | | | | | | | |
| coefficient (ppm) | | | | | | | | | | | | | | |
| Glass transition | −30 ± 10 | −30 ± 10 | −30 ± 10 | −30 ± 10 | −30 ± 10 | −30 ± 10 | −30 ± 10 | −30 ± 10 | −30 ± 10 | −30 ± 10 | −30 ± 010 | −30 ± 010 | −30 ± 010 | −30 ± 010 |
| temperature (° C.) | | | | | | | | | | | | | | |
| Viscosity @26° C. | 29000 | 29000 | 29000 | 29000 | 30000 | 29000 | 27000 | 31000 | 37000 | 56000 | 28000 | 26000 | 27000 | 27000 |
| (mPa.s) | | | | | | | | | | | | | | |
| @150° C. Curing | 300 | 300 | 300 | 300 | 300 | 300 | 300 | 300 | 300 | 300 | 300 | 300 | 300 | 300 |
| time (s) | | | | | | | | | | | | | | |
| Volume resisivity | 2.1 × 10⁻⁴ | 1.9 × 10⁻⁴ | 0.85 × 10⁻⁴ | 0.87 × 10⁻⁴ | 0.92 × 10⁻⁴ | 1.1 × 10⁻⁴ | 17 × 10⁻⁴ | 2.4 × 10⁻⁴ | 2.35 × 10⁻⁴ | 8.7 × 10⁻⁴ | 2.2 × 10⁻⁴ | 1.9 × 10⁻⁴ | 0.7 × 10⁻⁴ | 8.0 × 10⁻⁴ |
| (Ω. cm) | | | | | | | | | | | | | | |
| Shear strength | 13.1 | 12.7 | 12.7 | 11.9 | 11.6 | 11.3 | 11.6 | 9.5 | 11.6 | 11.6 | 13.6 | 13.2 | 12.9 | 12.6 |
| (MPa) | | | | | | | | | | | | | | |
| Die Shearing | 33 | 32 | 34 | 35 | 33 | 32 | 35 | 32 | 32 | 33 | 25 | 37 | 35 | 34 |
| Strength (kg) | | | | | | | | | | | | | | |
| Printing | good | good | good | good | good | good | good | poor | good | difficult | good | good | good | good |
| performance | | | | | | | | | | | | | | |

The following conclusions can be drawn from Table 2:

1. The thermal expansion coefficient, glass transition temperature, and curing time of conductive adhesives of Example 1 to Example 12, and Comparative Example 1 to Comparative Example 2 are almost the same, leaving other results like viscosity, volume resistivity, shear strength, die shearing strength, and printing performance as some basic indications for determining material components composition ranges as claimed.

2. Comparing Comparative Example 1 and Comparative Example 2 with Example 5, the viscosity of conductive adhesives of Comparative Example 1 and Comparative Example 2 is slightly lower than that of Example 5, but the viscosity of All conductive adhesives of Comparative Example 1, Comparative Example 2 and Example 5 have good printability. It shows that even if the conductive particles in the conductive adhesive are all conductive particles with a three-dimensional dendritic microstructure, it can be still prepared with good printability. However, the volume resistivity of the conductive adhesive in Comparative Example 1 and Comparative Example 2 is significantly higher than that of Example 1 to Example 9, indicating that the conductivity of the conductive adhesive in Comparative Example 1 and Comparative Example 2 is poor. Thus, if the conductive particles in the conductive adhesive only contain spherical conductive particles or flaky conductive particles, the volume resistivity of the conductive adhesive will increase and the conductivity will deteriorate. This suggests that when the weight of the conductive particles used in the conductive adhesive is the same, the use of three-dimensional dendritic conductive particles can reduce the volume resistivity of the conductive adhesive and improve the conductivity. It is noted that by including at least 5% three-dimensional dendritic conductive particles among the conductive particles in the conductive adhesive the volume resistivity can be reduced comparing to the high resistivities shown in Comparative Example 1 and Comparative Example 2. It is noted that the three-dimensional dendritic conductive particles among the conductive particles may be increased to 95% to have a relative low volume resistivity, yet further increasing concentration of the three-dimensional dendritic conductive particles may not further reduce volume resistivity other than cause higher cost.

3. Comparing Example 10 with Example 5, because of the increase in the specific surface area of the conductive particles with three-dimensional dendritic microstructure, the volume resistivity of the conductive adhesive in Example 10 is significantly higher than that of Example 5, and the viscosity of the conductive adhesive is also significantly higher than the viscosity of Example 5, resulting in printing difficulties. Therefore, to ensure the conductivity and printability of the conductive adhesive, the specific surface area of the conductive particles with three-dimensional dendritic microstructure shall be limited to a proposed range of 0.2˜3.5 m²/g. This is because the specific surface area may affect the electrical conductivity of the conductive adhesive, so the specific surface area of the conductive particles with the three-dimensional dendritic microstructure of the present disclosure needs to be in the range of 0.2 to 3.5 m²/g to yield acceptable electrical conductivity. Example 11 has the same dendritic microstructure in conductive particles with a small D50 and a high specific surface area as Example 10 while the viscosity of Example 11 is reduced from 56000 mPa·s to 28000 mPa·s by having composition of polyurethane modified epoxy acrylate mixed in the adhesive increased from 28 parts to 43 parts. This suggests that adjusting the polyurethane modified epoxy acrylate from lower side in a proposed range of 24˜45 parts to higher side of the range may help to reduce the viscosity and enhance the printing performance, at the same time reducing volume resistivity. In Example 12, the conductive particles contain both the conductive particles with the dendritic microstructure and spherical silver particles in the adhesive, given a same. The dendritic conductive particles has a larger D50 of 4.0 μm and a smaller specific surface area of 0.69 m²/g than those of Example 10. The polyurethane modified epoxy acrylate in Example 12 also higher parts amount than that in Example 10. Both the higher number of parts of polyurethane modified epoxy acrylate and the lower smaller specific surface area lead to a reduced viscosity and reduced volume resistivity with Example 12.

4. Comparing Example 11 and Example 12 with the Comparative Example 1 and Comparative Example 2, it can be found that the volume resistivity of the Example 11 and Example 12 is lower than the Comparative Example 1 and Comparative Example 2 while the silver content of the Example 11 and Example 12 is 55% and 60% comparing the 70% of the silver content of the Comparative Example 1 and Comparative Example 2. This suggests that even though the silver content in the conductive particles is lower, adding the conductive particles with dendritic structure to just a portion of total conductive particles can significantly reduce the volume resistivity of the conductive adhesive.

Although a limited number of examples are shown above, much more sample products are produced based on various raw material combinations with similar tests being done, which are combined to identify some embodiments presented in this disclosure. In particular, a modified epoxy acrylate resin conductive adhesive is provided, based on 100 parts by total mass, including raw material components: 49˜75 parts of conductive particles, 24˜45 parts of modified epoxy acrylate resin, 0.5˜2.5 parts of silane coupling agent, and 0.5˜3.0 parts of initiator. Among the conductive particles, at least 5% of them are characterized by a three-dimensional dendritic microstructure. Optionally, the specific surface area of the conductive particles with the three-dimensional dendritic microstructure is limited in a range of 0.2˜3.5 m²/g.

Optionally, for forming the modified acrylate resin conductive adhesive, based on 100 parts by total mass, 49˜53 parts of the conductive particles partially containing the three-dimensional dendritic microstructure are selected to be used for producing the modified acrylate resin conductive adhesive. Optionally, 53˜57 parts of the conductive particles partially containing the three-dimensional dendritic microstructure are used. Optionally, 57˜61 parts of the conductive particles partially containing the three-dimensional dendritic microstructure are used. Optionally, 61˜64 parts of the conductive particles partially containing the three-dimensional dendritic microstructure are used. Optionally, 64˜69 parts of the conductive particles partially containing the three-dimensional dendritic microstructure are used. Optionally, 69˜72 parts of the conductive particles partially containing the three-dimensional dendritic microstructure are used. Optionally, 72˜75 parts the conductive particles partially containing the three-dimensional dendritic microstructure are used. Optionally, 24˜27 parts of modified epoxy acrylate resin are used. Optionally, 27˜30 parts of modified epoxy acrylate resin are used. Optionally, 30˜34 parts of modified epoxy acrylate resin are used. Optionally, 34˜38 parts of modified epoxy acrylate resin are used. Optionally, 38˜43 parts of modified epoxy acrylate resin are used. Optionally, 43˜45 parts of modified epoxy acrylate resin are used. Optionally, 0.5˜0.8 parts of silane coupling agent are used. Optionally, 0.8˜1.1 parts of silane coupling agent are used. Optionally, 1.1˜1.5 parts of silane coupling agent are used. Optionally, 1.5˜1.9 parts of silane coupling agent are used. Optionally, 1.9˜2.2 parts of silane coupling agent are used. Optionally, 2.2˜2.5 parts of silane coupling agent are used. Optionally, 0.5˜0.8 parts of initiator are used. Optionally, 0.8˜1.1 parts of initiator are used. Optionally, 1.1˜1.4 parts of initiator are used. Optionally, 1.4˜1.8 parts of initiator are used. Optionally, 1.8˜2.2 parts of initiator are used. Optionally, 2.2˜2.5 parts of initiator are used. Optionally, 2.5˜2.8 parts of initiator are used. Optionally, 2.8˜3.0 parts of initiator are used.

In some embodiments, the conductive particles include conductive particles with a three-dimensional dendritic microstructure. It is noted that the conductive adhesive of the present disclosure must contain three-dimensional dendritic conductive particles. Optionally, the conductive particles in the conductive adhesive of the present disclosure include at least 5% conductive particles with the three-dimensional dendritic microstructure among all the conductive particles. Optionally, the conductive particles in the conductive adhesive of the present disclosure includes a mixture of the conductive particles with the three-dimensional dendritic microstructure and conductive particles in spherical or flaky shapes.

Optionally, the modified acrylate resin conductive particles with a three-dimensional dendritic microstructure are silver particles with a three-dimensional dendritic microstructure and/or silver-coated copper particles with a three-dimensional dendritic microstructure. Optionally, the conductive particles are a mixture of spherical silver particles and silver particles with a three-dimensional dendritic microstructure, wherein a mass ratio of the silver particles with the three-dimensional dendritic microstructure and total of the conductive particles is one selected from (0.05˜0.95):1. In addition, by selecting the specific surface area and the particle size in above two numerical ranges, respectively, the modified acrylate resin conductive adhesive of the disclosure can be applied to different scenarios. Generally, the median particle diameter D50 of the conductive particles with a three-dimensional dendritic microstructure is varied in a flexible range of 0.1 μm to 50.0 μm. Optionally, the specific surface area of the silver particles with the three-dimensional dendritic microstructure is limited in a range of 0.2˜3.5 m²/g to ensure both good conductivity and printability. Optionally, the size of the spherical silver particles is varied in a flexible range of 0.1˜50.0 μm.

Optionally, the conductive particles are a mixture of spherical silver particles and silver-coated copper particles with a three-dimensional dendritic microstructure, wherein a mass ratio of the silver-coated copper particles with the three-dimensional dendritic microstructure to total of the conductive particles is one selected from (0.05˜0.95):1. In addition, the specific surface area of the silver-coated copper particles with the three-dimensional dendritic microstructure is limited in a range of 0.2˜3.5 m²/g. The particle size of the spherical silver particles is varied in a range of 0.1˜50.0 μm.

Optionally, the conductive particles also include flaky silver particles. The conductive particles are a mixture of flaky silver particles and silver particles with a three-dimensional dendritic microstructure. A mass ratio of the silver particles with the three-dimensional dendritic microstructure to total of the conductive particles is one selected from (0.05˜0.95):1. In addition, the specific surface area of the silver particles with the three-dimensional dendritic microstructure is limited in a range of 0.2˜3.5 m²/g. The size of the flaky silver particles is in a range of 0.1˜50.0 μm.

Optionally, the conductive particles are a mixture of flaky silver particles and silver-coated copper particles with a three-dimensional dendritic microstructure. A mass ratio of the silver-coated copper particles with the three-dimensional dendritic microstructure to total of the conductive particles is one selected from (0.05˜0.95):1. In addition, the specific surface area of the silver-coated copper particles with the three-dimensional dendritic microstructure is limited in a range of 0.2˜3.5 m²/g. The size of the flaky silver particles is in a range of 0.1˜50.0 μm.

Optionally, the conductive particles are a mixture of flaky silver-coated copper particles and silver-coated copper particles with a three-dimensional dendritic microstructure. A mass ratio of the silver-coated copper particles with the three-dimensional dendritic microstructure to total of the conductive particles is one selected from (0.05˜0.95):1. In addition, the specific surface area of the silver-coated copper particles with the three-dimensional dendritic microstructure is limited in a range of 0.2˜3.5 m²/g. The size of the flaky silver-coated copper particles is in a range of 0.1˜50.0 μm.

Optionally, the conductive particles are a mixture of spherical silver-coated copper particles and silver-coated copper particles with a three-dimensional dendritic microstructure. A mass ratio of the silver-coated copper particles with the three-dimensional dendritic microstructure to total of the conductive particles is one selected from (0.05˜0.95):1. In addition, the specific surface area of the silver-coated copper particles with the three-dimensional dendritic microstructure is limited in a range of 0.2˜3.5 m²/g. The size of the spherical silver-coated copper particles is in a range of 0.1˜50.0 μm.

Optionally, the conductive particles are a mixture of silver particles with a three-dimensional dendritic microstructure and silver-coated copper particles with a three-dimensional dendritic microstructure. A mass ratio of the silver-coated copper particles with the three-dimensional dendritic microstructure to total of the conductive particles is one selected from (0.05˜0.95):1. In addition, the specific surface area of the silver-coated copper particles with the three-dimensional dendritic microstructure is limited in a range of 0.2˜3.5 m²/g. The specific surface area of the silver particles with the three-dimensional dendritic microstructure is limited in a range of 0.2˜3.5 m²/g.

Optionally, the modified epoxy acrylate resin is at least one of polyurethane modified epoxy acrylate, silicone modified epoxy acrylate, acid and anhydride modified epoxy acrylate, phosphoric acid (ester) modified epoxy acrylate, and polyol modified epoxy acrylate. That is to say, in the specific embodiment, the modified epoxy acrylate resin can be any one of the above-mentioned acrylate monomers, or it can be any two or a combination of two or more of the above-mentioned acrylate monomers.

Optionally, the silane coupling agent is at least one of 3-methacryloxypropyldimethoxysilane, 3 -methacryloxypropyltrimethoxysilane, 3-methacryloxypropyldiethyl Oxysilane, 3-methacryloxypropyl triethoxy silane, vinyl trimethoxy silane, vinyl triethoxy silane, styrene trimethoxy silane, 3-acrylic propyl trimethoxy silane. That is, in the specific embodiment, the silane coupling agent can be selected from one or more of the above listed silane coupling agents according to actual needs, the purpose of which is to enhance the effect of adhesion.

Optionally, the silane coupling agent used in the present disclosure can set up a “molecular bridge” between the conductive adhesive and the interface between the semiconductor element that needs to be bonded, such as a chip, to connect two materials with very different properties together, and increase the bonding strength.

Optionally, the initiator is at least one of tert-butyl peroxide neodecanoate, tert-butyl peroxide 2-ethylhexyl acid, 1,1′-bis(tert-butylperoxy)-3,3,5-trimethylcyclohexane alkane, 1,1′-bis(tert-amylperoxy)cyclohexane; that is, in specific embodiments, the initiator can be selected from the above listed initiators according to actual needs. The purpose of the initiator is to initiate a curing reaction to form the conductive adhesive.

Furthermore, if the modified acrylate resin conductive adhesive contains only conductive particles with three-dimensional dendritic microstructure, the viscosity of the conductive adhesive may increase, and even affect the printing type of the conductive adhesive. Therefore, in the present disclosure, in order to reduce the viscosity of the conductive adhesive on the basis of ensuring that the electrical conductivity of the conductive adhesive does not change significantly, so that the modified acrylate resin conductive adhesive has better printability, the conductive particles of the present disclosure also include one or more kinds of, but are not limited to, spherical conductive particles, flaky conductive particles, or spheroidal conductive particles. Optionally, the weight ratio of the spherical conductive particles, flaky conductive particles, or spheroidal conductive particles to the conductive particles with three- dimensional microstructure is one selected from (0.05˜0.95):1.

In another aspect, the present disclosure also provides a method for preparing the modified epoxy acrylate resin conductive adhesive described herein. The method includes 1), according to total mass parts as 100 parts, weighing the following raw material components: 49˜75 parts of conductive particles, 24˜45 parts of modified epoxy acrylate resin, 0.5˜2.5 parts of silane coupling agent, 0.5˜3.0 parts of initiator. It is noted that weighing the raw material components subjects to about 10% error margin. The conductive particles include at least 5% conductive particles with a three-dimensional dendritic microstructure with rest conductive particles being spherical or flaky shaped particles. Optionally, the conductive particles, either in the three-dimensional dendritic or spherical or flaky shape, contains silver or copper coated by silver. Additionally, the method includes 2) mixing the modified glycidyl ester resin, silane coupling agent and initiator described in step 1) into the reaction, stirring evenly, then adding the conductive particles, stirring evenly to obtain a mixture. Furthermore, the method includes 3) grinding the mixture to obtain the modified epoxy acrylate resin conductive adhesive.

In yet another aspect, the present disclosure provides a method for using the modified epoxy acrylate resin conductive adhesive described herein to semiconductor components. The method of using the above-mentioned modified epoxy acrylate resin conductive adhesive in semiconductor components includes 1) printing the modified epoxy acrylate resin conductive adhesive described herein on a substrate of a semiconductor element. Additionally, the method includes 2) disposing the substrate printed with the modified acrylate resin conductive adhesive in an environment at 80° C. to 170° C. (for example, 150° C.). Furthermore, the method includes 3) curing the printed modified acrylate resin conductive adhesive in the environment for 5˜300 s (for example, 15 s) to obtain the semiconductor element containing a cured modified epoxy acrylate resin conductive adhesive to be ready for being packaged into a semiconductor device.

The present disclosure has been described in detail with reference to preferred embodiments above, which however are not intended to limit the present disclosure. Any modifications, equivalent substitutions and improvements can be made without departing from the spirit and principle of the present disclosure, which are all fall within the protection scope of the present disclosure.

What is claimed is:

1. A modified epoxy acrylate resin conductive adhesive comprising, based on 100 parts by weight,
49˜75 parts of conductive particles,
24˜45 parts of modified epoxy acrylate resin,
0.5˜2.5 parts of silane coupling agent,
0.5˜3.0 parts of initiator;
wherein the conductive particles include three-dimensional dendritic conductive particles.

2. The modified epoxy acrylate resin conductive adhesive of claim 1, wherein the three-dimensional dendritic conductive particles are characterized by a specific surface area limited in a range of 0.2˜3.5 m²/g.

3. The modified epoxy acrylate resin conductive adhesive of claim 2, wherein the three-dimensional dendritic conductive particles comprise one or a mixture of both three-dimensional dendritic silver particles and three-dimensional dendritic silver-coated copper particles.

4. The modified epoxy acrylate resin conductive adhesive of claim 1, wherein the conductive particles comprise a mixture of spherical silver particles and three-dimensional dendritic silver particles, wherein a mass ratio of the three-dimensional dendritic silver particles to total of the conductive particles is one selected from (0.05 to 0.95):1, the three-dimensional dendritic silver particles are characterized by a specific surface area limited in a range of 0.2˜3.5 m²/g, and the spherical silver particles are characterized by particle sizes in a range of 0.1˜50 μm.

5. The modified epoxy acrylate resin conductive adhesive of claim 1, wherein the conductive particles comprise a mixture of spherical silver particles and three-dimensional dendritic silver-coated copper particles, wherein a mass ratio of the three-dimensional dendritic silver-coated copper particles to total of the conductive particles is one selected from (0.05 to 0.95):1, the three-dimensional dendritic silver-coated copper particles are characterized by a specific surface area limited in a range of 0.2˜3.5 m²/g, and the spherical silver particles are characterized by particle sizes in a range of 0.1˜50 μm.

6. The modified epoxy acrylate resin conductive adhesive of claim 1, wherein the conductive particles comprise a mixture of flaky silver particles and three-dimensional dendritic silver particles, wherein a mass ratio of the three-dimensional dendritic silver particles to total of the conductive particles is one selected from (0.05 to 0.95):1, the three-dimensional dendritic silver particles are characterized by a specific surface area limited in a range of 0.2˜3.5 m²/g, and the flaky silver particles are characterized by particle sizes in a range of 0.1˜50 μm.

7. The modified epoxy acrylate resin conductive adhesive of claim 1, wherein the conductive particles comprise a mixture of flaky silver particles and three-dimensional dendritic silver-coated copper particles, wherein a mass ratio of the three-dimensional dendritic silver-coated copper particles to total of the conductive particles is one selected from (0.05 to 0.95):1, the three-dimensional dendritic silver-coated copper particles are characterized by a specific surface area limited in a range of 0.2˜3.5 m²/g, and the flaky silver particles are characterized by particle sizes in a range of 0.1˜50 μm.

8. The modified epoxy acrylate resin conductive adhesive of claim 1, wherein the conductive particles comprise a mixture of flaky silver-coated copper particles and three-dimensional dendritic silver-coated copper particles, wherein a mass ratio of the three-dimensional dendritic silver-coated copper particles to total of the conductive particles is one selected from (0.05 to 0.95):1, the three-dimensional dendritic silver-coated copper particles are characterized by a specific surface area limited in a range of 0.2˜3.5 m²/g, and the flaky silver-coated copper particles are characterized by particle sizes in a range of 0.1˜50 μm.

9. The modified epoxy acrylate resin conductive adhesive of claim 1, wherein the conductive particles comprise a mixture of spherical silver-coated copper particles and three-dimensional dendritic silver-coated copper particles, wherein a mass ratio of the three-dimensional dendritic silver-coated copper particles to total of the conductive particles is one selected from (0.05 to 0.95):1, the three-dimensional dendritic silver-coated copper particles are characterized by a specific surface area limited in a range of 0.2˜3.5 m²/g, and the spherical silver-coated copper particles are characterized by particle sizes in a range of 0.1˜50 μm.

10. The modified epoxy acrylate resin conductive adhesive of claim 1, wherein the conductive particles are a mixture of three-dimensional dendritic silver particles and three-dimensional dendritic silver-coated copper particles, wherein a mass ratio of the three-dimensional dendritic silver-coated copper particles to total of the conductive particles is one selected from (0.05 to 0.95):1, the three-dimensional dendritic silver particles are characterized by a specific surface area limited in a range of 0.2˜3.5 m²/g, and the three-dimensional dendritic silver-coated copper particles are characterized by a specific surface area limited in a range of 0.2˜3.5 m²/g.

11. The modified epoxy acrylate resin conductive adhesive of claim 3, wherein the three-dimensional dendritic silver particles are characterized by particle sizes in a range of 0.2˜50 μm.

12. The modified epoxy acrylate resin conductive adhesive of claim 3, wherein the three-dimensional dendritic silver-coated copper particles are characterized by particle sizes in a range of 0.2˜50 μm.

13. The modified epoxy acrylate resin conductive adhesive of claim 1, wherein the modified epoxy acrylate resin is at least one kind of polyurethane modified epoxy acrylate, silicone modified epoxy acrylate, acid and anhydride modified epoxy acrylate, phosphate modified epoxy acrylate, and polyol modified epoxy acrylate.

14. The modified epoxy acrylate resin conductive adhesive of claim 1, wherein the silane coupling agent is at least one kind of 3-methacryloxypropyldimethoxysilane, 3-methacryloxypropyltrimethoxysilane, 3-methacryloxypropyl diethyl Oxysilane, 3-methacryloxypropyl triethoxy silane, vinyl trimethoxy silane, vinyl triethoxy silane, styrene trimethoxy silane, 3-acrylic propyl trimethoxy silane.

15. The modified epoxy acrylate resin conductive adhesive of claim 1, wherein the initiator is at least one kind of tert-butyl peroxide neodecanoate, tert-butyl peroxide 2-ethylhexyl acid, 11′-bis(tert-butylperoxy)-3,3,5-trimethylcyclohexane, At least one of 1,1′-bis(tert-amylperoxy)cyclohexane.

16. A method for preparing a modified epoxy acrylate resin conductive adhesive comprising:
weighing, based on the total weight of 100 parts, 49˜75 parts of conductive particles, 24˜45 parts of modified epoxy acrylate resin, 0.5˜2.5 parts of silane coupling agent, and 0.5˜3.0 parts of initiator; wherein the conductive particles include three-dimensional dendritic conductive particles;
disposing the acrylate, the silane coupling agent, and the initiator in a reactor and stirring evenly, then adding the conductive particles and stirring evenly to obtain a mixture; and
grinding the mixture to obtain the modified epoxy acrylate resin conductive adhesive.

17. A method of using the modified epoxy acrylate resin conductive adhesive according to claim 1 comprising:
printing the modified epoxy acrylate resin conductive adhesive on a substrate of a semiconductor element;
disposing the substrate printed with the modified acrylate resin conductive adhesive in an environment at 80° C. to 170° C.; and
curing the modified epoxy acrylate resin conductive adhesive on the substrate in an environment at 80° C. to 170° C. for 5˜300 seconds to obtain the semiconductor element containing a cured modified epoxy acrylate resin conductive adhesive to be ready for being packaged into a semiconductor device.
